(19) United States
(12) Patent Application Publication
(10) Pub. No.: US 2024/0348038 A1
(43) Pub. Date: Oct. 17, 2024

(54) Self Installed Fire Protection Unit.

(71) Applicant: Albert Robert LOWES, Hot Springs National Park, AR (US)

(72) Inventor: Albert Robert LOWES, Hot Springs National Park, AR (US)

(21) Appl. No.: 18/445,122

(22) Filed: Apr. 17, 2023

(51) Int. Cl. H02H 3/16; H02H 1/00

(52) U.S. Cl. CPC H02H 3/16; H02H 1/0015

(57) ABSTRACT

Most home fire causes are cooking related; most fire deaths are caused by night fires. A high percentage of night fires are caused by electrical faults. The Self Installed Fire Protection Unit will detect a high percentage electrical faults that lead to fires. For nighttime protection it's best installed in high current circuits that operate at night. Its low cost with no need to alter the buildings wiring may encourage its use.

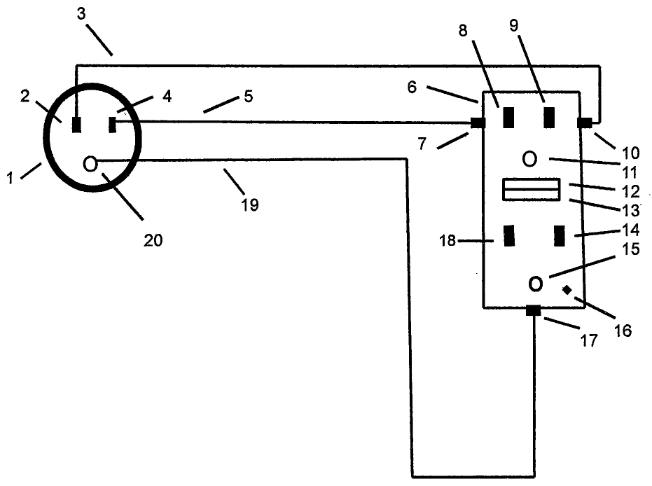

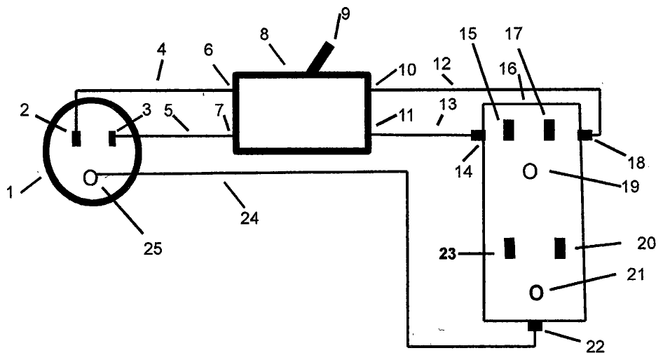

### RELATED APPLICATION

Provisional patents. No. 63/372,981 date Apr. 18, 2022 name Fire protection unit. No. 63/473,107 date Apr. 30, 2022 name Protect electrical circuits with arc-fault circuit with ark-fault receptacle without changing building wiring.

### BACKGROUND

Recently built buildings and buildings with updated electrical wiring that include Ark Fault Circuit Interrupters have fewer fires. The Self Installed Fire Protection Unit inserts an Art Fault Circuit interrupter into the current path of a building's electrical circuit increasing fire protection with a low cost.

### BRIEF SUMMARY OF THE INVENTION

The Self Installed Fire Protection Unit checks the electrical waveform for series arc faults, from the electrical box, through all in between connections, through the Self Installed Fire Protection Unit, the power cord, and any equipment plugged into it that is drawing current. It checks for both series, and parallel arc faults from the Fire Protection Units output socket through the power cord, and in the operating equipment.

### BRIEF DESCRIPTION OF THE DRAWINGS

### Drawing 1

Illustrates the use of an Arc Fault Circuit Interrupter intended for installation in a building receptacle box is repurposed for the present invention.

### Drawing 2

Illustrates the use of an Arc Fault Circuit Interrupter Circuit Breaker intended for installation in a building electrical distribution box is repurposed for the present invention.

### DETAILED DESCRIPTION OF THE DRAWINGS

### Drawing 1

Illustrates the operation of the preferred embodiment of the invention that utilizes an AFCI Receptacle or a AFCI/GFCI Receptacle, in operation plug 1, is inserted into a building receptacle, pin 2. Connects live power to wire 3 that connects power to 10. the power input of the Receptacle Ark Fault Circuit Interrupter 6. Return neutral current flows out of connection 7. though wire 5. To the neutral pin 4. Of plug 1. The ground connection from plug 1. Pin 20. Is connected by wire 19. To connection 17. The ground connection of the Ark Fault Circuit Interrupter. 8. Is the live plug socket. 9. Is a neutral connection plug socket. 11. Is the ground plug socket. 12. Is the test button. 13 Is the reset button. 14. Is the neutral plug socket. 15. Is a ground plug socket 16. Is the indicator LED. 18. Is the live plug socket.

### Drawing 2

Illustrates the operation of the preferred embodiment of the invention that utilizes a AFCI Breaker or a AFCI/GFCI Breaker In operation plug 1. Is inserted into a building receptacle. Pin 2. Of Plug 1. Connect power through wire 4. To 8. The Circuit Breakers input pin 6. When switch 9. Is in the on position. Power from connection 10. Is connected to wire 12. That connects to socket 18. Power input pin. Return power flows from connection 14, Though wire 13. To the Circuit Breaker 8. Neutral connection 11. Flows though the breaker out of connection 7. though wire 5. Connecting to pin 3. The neutral pin of plug 1. Switch 10. Is used to reset the Ark Fault Breaker if it trips cutting the power output.

1. An apparatus comprising of a input plug,
a ark fault detector,
a one or more output receptacle sockets,

2. The apparatus of claim one further containing a Ark Fault Detector combined with a ground fault detector,

3. The apparatus of claims 1, and 2 that contains a power disconnect capability.

4. The apparatus of claim I that sound a audible alarm, without disconnecting the power to the receptible on.

5. The apparatus according to claims 1 2 3, and 4 that can be installed then removed without altering the building wiring.
